(19) United States
(12) Patent Application Publication
(10) Pub. No.: US 2007/0003801 A1
(43) Pub. Date: Jan. 4, 2007

(54) Fuel cell

(75) Inventor: Yurika Koizumi, Ora-Gun (JP)

Correspondence Address: MCDERMOTT WILL & EMERY LLP, 600 13TH STREET, N.W., WASHINGTON, DC, 20005-3096, US

(73) Assignee: Sanyo Electric Co., Ltd.

(21) Appl. No.: 11/475,178

(22) Filed: Jun. 27, 2006

(30) Foreign Application Priority Data
Jun. 30, 2005 (JP) 2005-192745
May 29, 2006 (JP) 2006-147945

(51) Int. Cl. H01M 8/00; H01M 8/22

(52) U.S. Cl. 429/12

(57) ABSTRACT

A fuel cell that prevents the cross-over of liquid fuel within the fuel cell and the drop in cell voltage due to methanol oxidization on a cathode so as to enhance cell characteristics. A cell according to the present invention is provided with an anode and a cathode at both sides of an electrolyte layer, supplies liquid fuel to the anode, supplies oxidant to the cathode, and contains a fuel complexation material which forms a complex with a liquid fuel.

### BACKGROUND OF THE INVENTION

1. Field of the Invention

The present invention relates to a fuel cell that supplies the liquid fuel directly to the fuel cell so as to produce electric power.

2. Description of the Related Art

A fuel cell is a device that generates electricity from hydrogen and oxygen so as to obtain highly efficient power generation. A principal feature of a fuel cell is its capacity for direct power generation which does not undergo a stage of thermal energy or kinetic energy as in conventional power generation. This presents such advantages as high power generation efficiency despite the small scale setup, reduced emission of nitrogen compounds and the like, and environmental friendliness on account of minimal noise or vibration. A fuel cell is capable of efficiently utilizing chemical energy in its fuel and as such environmentally friendly. Fuel cells are therefore envisaged as an energy supply system for the twenty-first century and have gained attention as a promising power generation system that can be used in a variety of applications including space applications, automobiles, mobile devices, and large and small scale power generation. Serious technical efforts are being made to develop practical fuel cells.

Of various types of fuel cells, a polymer electrolyte fuel cell (PEFC) excels in its low operating temperature and high output density. Recently, direct methanol fuel cells (DMFC) are especially attracting the attention as a type of polymer electrolyte fuel cell. In a DMFC, methanol water solution as a fuel is not reformed and is directly supplied to the anode so that electricity is produced by an electrochemical reaction induced between the methanol water solution and oxygen. Discharged as reaction products resulting from the electrochemical reaction are carbon dioxide emitted from the anode and generated water emitted from the cathode. Methanol water solution has a higher energy density per unit volume than hydrogen. Moreover, it is suitable for storage and poses little danger of explosion. Accordingly, it is expected that methanol water solution will be used in power supplies for automobiles, mobile devices (cell phones, notebook personal computers, PDAs, MP3 players, digital cameras, electronic dictionaries and books) and the like.

In this DMFC, a phenomenon called a crossover takes place, in which methanol supplied to the anode, in an unreacted state, passes through the electrolyte membrane and reaches the cathode. This methanol having crossed-over gets oxidized on the cathode, which causes a drop in cell voltage and thus a reduced output of the cell.

A proposed solution to this problem has been a structure in which moisture is supplied to the cathode side to wet the electrolyte membrane sufficiently so as to reduce the transfer of water from anode to cathode and thereby reduce the permeation of liquid fuel therethrough (See Reference (1) in the following Related Art List, for instance). However, this arrangement requires a means to humidify the oxidizing agent to be supplied to the cathode, thus adding a problem where the system becomes more complex.

Related Art List

(1) Japanese Patent Application Laid-Open No. 2004-220844.

As described above, a conventional fuel cell has the problem of cell voltage drop and reduced output thereof because methanol (liquid fuel) supplied to the anode crosses over, in an unreacted state, to the cathode by permeating the electrolyte membrane. And a configuration as proposed in Reference (1) to solve this problem contributes to making the system more complex.

### SUMMARY OF THE INVENTION

The present invention has been made in view of the foregoing circumstances and a general purpose thereof is to provide a fuel cell that prevents the drop in cell voltage due to methanol oxidization on the cathode and enhances cell characteristics by reducing the crossover of liquid fuel therein.

In order to solve the above problems, a cell according to one embodiment of the present invention is a cell in which an anode and a cathode is provided at both sides of an electrolyte layer, liquid fuel is supplied to the anode and oxidant is supplied to the cathode, and the cell includes a fuel complexation material which forms a complex with a liquid fuel. Here, the complex is an aggregate of ions and atoms where different kinds of ions, molecules and polyatomic ions are bonded together with the central ion or central atom. The fuel complexation material is a material, such as cyclic hemiketal and boron trifluoride, that can form a complex by combining with a fuel which can be directly supplied to the cell in the state of liquid. The anode is an electrode provided with an anode catalyst layer where the electrochemical reaction to oxidize the fuel takes place. The cathode is an electrode provided with a cathode catalyst layer where the electrochemical reaction to reduce the oxidant takes place. According to this embodiment, the complex is formed by the fuel complexation material and the liquid fuel. As a result, the crossover of the liquid fuel within a cell can be reduced and therefore the drop in voltage due to methanol oxidization on the cathode can be prevented and the cell characteristics can be enhanced.

In a cell according to the above embodiment, there may be further provided a fuel complexation layer, provided at an anode side of the electrolyte layer, which contains the fuel complexation material. According to this embodiment, a fuel complexation layer which contains the fuel complexation material is provided at an anode side of the electrolyte layer. Hence, the so-called “crossover” in which methanol supplied to the anode, in an unreacted state, passes through the electrolyte membrane and migrates to the cathode can be prevented.

In a cell according to the above embodiment, the fuel complexation layer may be provided at least at the anode side of the electrolyte layer and on a surface on which the anode is not placed. According to this embodiment, the fuel complexation layer is provided at least at the anode side of the electrolyte layer and on a surface on which the anode is not disposed. Hence, the liquid fuel, supplied to the anode side, which is in direct contact with an electrolyte layer on which no anode is formed can be suppressed from being crossed over to the electrolyte layer.

In a cell according to the above embodiment, the fuel complexation layer may contain cation exchanger. According to this embodiment, the cation exchanger contained further in the fuel complexation layer can enhance the binding property between fuel complexation materials and at the same time can improve the adhesiveness between the anode and the electrolyte layer via the fuel complexation layer. Furthermore, the protons produced in the anodic reaction can be conducted to the electrolyte layer more efficiently.

In a cell according to the above embodiment, the fuel complexation material may be cyclic hemiketal or boron trifluoride. Also, in a cell according to the above embodiment, the liquid fuel may contain methanol. According to this embodiment, the methanol supplied to the anode can be effectively prevented from being crossed over to the cathode and at the same time the high-output power generation can be achieved by using the methanol fuel.

Another embodiment of the present invention relates to a fuel cell. This fuel cell uses a cell according to any of the above-described embodiments.

In addition thereto, by employing a structure where the fuel complexation material is contained in the anode catalyst layer, the liquid fuel supplied to the anode can be held within the anode catalyst layer and therefore the migration of the liquid fuel to the cathode through the electrolyte layer can be prevented.

The anode catalyst layer is structured by the stacking of a first catalyst layer containing catalyst power and cation exchanger and a second catalyst layer containing catalyst powder, cation exchanger and fuel complexation material wherein the second catalyst layer can be so arranged as to be in contact with an electrolyte layer. With this structure, the liquid fuel supplied to the anode first permeates the first catalyst layer and subsequently the liquid fuel which has not contributed to the anodic reaction permeates the second catalyst layer, so that an anodic reaction takes places in the second catalyst layer and the surplus liquid fuel which has not been used can be stored. As a result, the surplus liquid can be stored efficiently in a number of regions in the anode catalyst layer without interfering with the anodic reaction and the transfer of the liquid fuel to the cathode can be prevented.

The arrangement may also be such that the anode catalyst layer contains catalyst powder, cation exchanger and fuel complexation material and such that the fuel complexation material increases in content in the thickness direction of anode catalyst layer toward the electrolyte layer. As a result, the surplus liquid can be stored efficiently in a number of regions in the anode catalyst layer without interfering with the anodic reaction and the transfer of the liquid fuel to the cathode can be prevented.

Also, by employing a structure where the fuel complexation material is contained in the electrolyte layer, the surplus liquid fuel, which has not contributed to the anodic reaction in the anode, in the liquid fuel supplied to the anode can be held within the electrolyte layer when it transfers to the cathode. In particular, a structure is such that the fuel complexation material is contained in a pore (ion cluster) of the electrolyte layer. Thus, when the liquid fuel is soluble in water, the fuel complexation material is contained in the ion cluster in the light of fact that the ion cluster, of the electrolyte layer, which serves as a passage for water can also serve as a passage for liquid fuel. Hence, in this case, the liquid fuel can be stored in the ion cluster and the migration of the liquid fuel to the cathode can be prevented.

A structure is provided such that a fuel complexation layer containing the fuel complexation material is disposed at the interface between the electrolyte layer and the anode. Thereby, the surplus liquid fuel, which has not contributed to the anodic reaction in the anode and has permeated the electrolyte layer, in the liquid fuel supplied to the anode can be stored at the interface between the electrolyte layer and the cathode. Hence, the migration of the liquid fuel to the cathode can be prevented. In addition to this advantageous aspects, by employing a structure wherein a fuel complexation layer contains a cation exchanger, the cation exchanger contained in the fuel complexation layer can not only enhance the binding property between fuel complexation materials but also improve the adhesiveness between the electrolyte layer and cathode via the fuel complexation layer. Furthermore, the protons conducted through the electrolyte layer can be conducted more efficiently to the cathode.

It is to be noted that any arbitrary combinations or rearrangement, as appropriate, of the aforementioned constituting elements and so forth are all effective as and encompassed by the embodiments of the present invention.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 schematically illustrates a principle of power generation by a fuel cell using methanol as a liquid fuel;

FIG. 2 is a cross sectional view of a cell according to a first embodiment of the present invention;

FIG. 3 is an assembly diagram showing major parts that constitute a fuel cell stack 111 according to a first embodiment of the present invention;

FIG. 4 schematically illustrates a mechanism of inhibition of a methanol cross-over by means of complexation;

FIG. 5 is a perspective view of a cell according to a second embodiment of the present invention;

FIG. 6 is a cross sectional view of the cell according to a second embodiment of the present invention;

FIG. 7 is a perspective view of a cell, in the second embodiment of the present invention, where an anode and a cathode thereof are comprised of an anode gas diffusion layer and a cathode diffusion layer, respectively;

FIG. 8 is a cross sectional view of a cell, in the second embodiment of the present invention, where a fuel complexation layer is formed, thicker than other regions, on a region in which no anode is formed;

FIG. 9 is a cross sectional view of a cell according to a third embodiment of the present invention;

FIG. 10 is a cross sectional view of a cell according to a fourth embodiment of the present invention;

FIG. 11 illustrates a structure of experimental apparatus using a two-chamber method; and

FIG. 12 is a graph showing a measurement result of methanol permeated.

### DETAILED DESCRIPTION OF THE INVENTION

The invention will now be described by reference to the preferred embodiments. This does not intend to limit the scope of the present invention, but to exemplify the invention.

The embodiments will now be described in detail with reference to drawings.

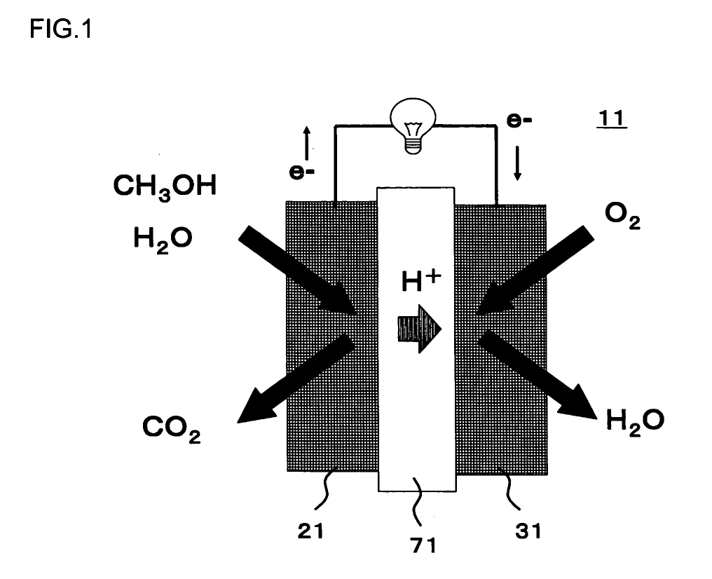

FIG. 1 schematically illustrates a principle of power generation by a fuel cell using methanol as the liquid fuel. A fuel cell 11 generates electric power by supplying methanol from a fuel supply source (not shown) directly to an anode (fuel electrode) 21 and oxygen contained in the air to a cathode (air electrode) 31. Methanol supplied to the anode 21 is oxidized by an anode catalyst, and an anodic reaction takes place at the anode 21 (See chemical formula 1).
CH₃OH+H₂O→CO₂+6H⁺+6e⁻ (Chemical formula 1)

Carbon dioxide generated in an anodic reaction at the anode 21 is released outside. Also, protons produced in the anodic reaction migrate across an electrolyte membrane 71 to the cathode 31, where they react with oxygen supplied thereto in an oxidation-reduction reaction to form water (See chemical formula 2).
3/2O₂+6H⁺+6e⁻→3H₂O (Chemical formula 2)

Electric power is thus generated through these reactions. It is to be noted that the power generated here is controlled by a control device (not shown), which serves as a control means for controlling power generation.

In the present embodiments, the electrolyte membrane 71 is, for instance, constituted of a perfluorosulfonic acid polymeric membrane (e.g., Nafion 117 made by DuPont in the U.S.), which is a cation exchanger, and the electrolyte membrane is, 175 μm thick, for instance. Also, the electrolyte membrane 71 is formed circumferentially larger than the anode 21 and the cathode 31 by predetermined dimensions, that is, by dimensions that do not cause any inconvenience in making the fuel cell 11 smaller.

### First Embodiment

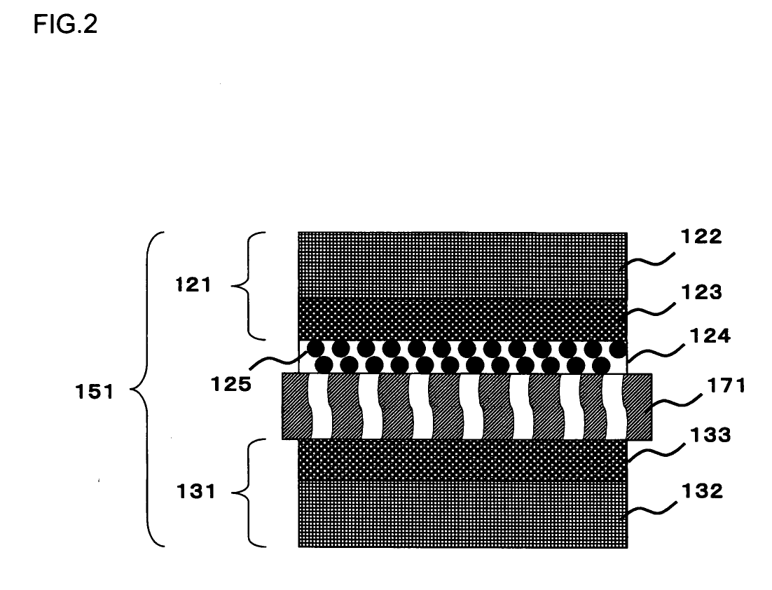

FIG. 2 is a cross sectional view of a cell 151 according to a first embodiment of the present invention.

An anode 121, as shown in FIG. 2, is of a laminated structure of a gas diffusion layer 122, an anode catalyst layer 123, and a fuel complexation layer 124 containing a fuel complexation material 125. A gas diffusion layer 122 of an anode 121 is produced by first preparing a slurry by mixing a polytetrafluoroethylene (PTFE) dispersion liquid as a water-repellent material with Cabot-made Vulcan XC-72 as a conductive material, then applying and filling with a blade knife the above-mentioned slurry on a carbon paper (200 μm thick, for instance) impregnated with FEP (a copolymer of ethylene tetrafluoride and propylene hexafluoride) to improve water repellence and strength as a conductive porous support, and finally burning the layer by heating it at 380° C.

The anode catalyst layer 123 is formed by first preparing a catalyst layer ink by mixing platinum-ruthenium black as catalyst powder with a 5 wt % solution of DuPont's Nafion as a cation exchanger and then applying the above-mentioned catalyst layer ink to the above-mentioned gas diffusion layer 122 by a screen printing method. In this case, the catalyst layer ink is prepared such that a weight ratio of the catalyst powder to the Nafion as the cation exchanger is 9 to 1. The whole surface of the anode catalyst layer 123 is sprayed with a solution dissolving a cyclic hemiketal as the fuel complexation material 125, thus forming the fuel complexation layer 124. In this manner, the anode 121 is formed.

On the other hand, as shown in FIG. 2, a cathode 131 is of a laminated structure of a gas diffusion layer 132 and a cathode catalyst layer 133. The gas diffusion layer 132 of a cathode 131, in the same way as the above-mentioned gas diffusion layer 122 of the anode 121, is produced by first preparing a slurry by mixing a polytetrafluoroethylene dispersion liquid as a water-repellent material with Cabot-made Vulcan XC-72 as a conductive material, then applying and filling with a blade knife the above-mentioned slurry on a carbon paper impregnated with FEP as a conductive porous support, and finally burning the layer by heating it at 380° C.

The cathode catalyst layer 133 is formed by first preparing a catalyst layer ink by mixing platinum black as catalyst powder with a 5 wt % solution of DuPont's Nafion as a cation exchanger and then applying the above-mentioned catalyst layer ink to the above-mentioned gas diffusion layer 132 by the screen printing method. In this case, too, the catalyst layer ink is prepared such that a weight ratio of the catalyst powder to the Nafion as the cation exchanger is 9 to 1. Thus the cathode 131 is formed.

And a cell 10, with an electrolyte membrane 171 held between the above-described anode 121 and cathode 131, is tight-molded by hot pressing at about 150° C., so that the anode 121, the electrolyte membrane 171 and the cathode 131 are joined in contact with one another.

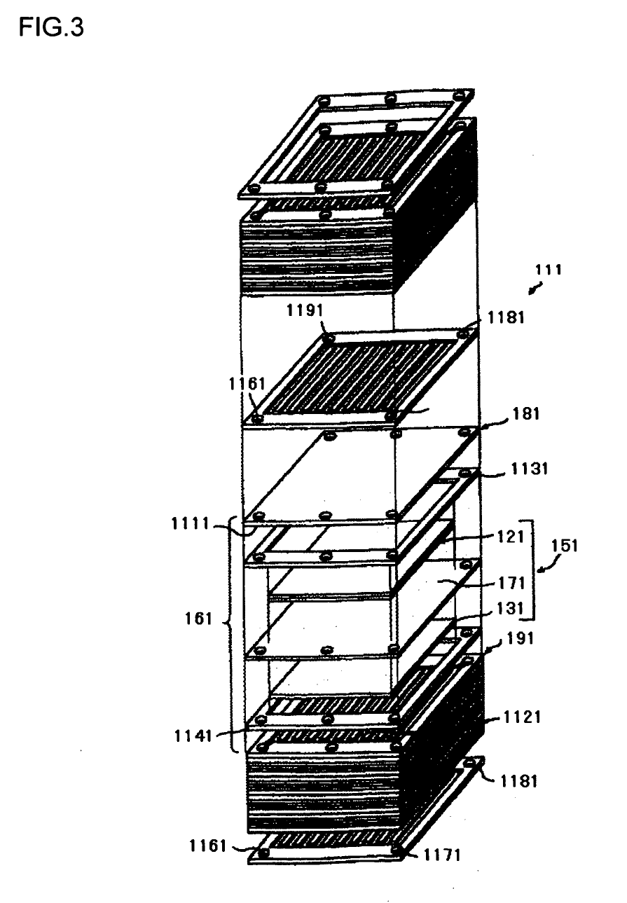

Now, referring to FIG. 3, a description will be given of a structure of a fuel cell stack 111 according to the first embodiment. FIG. 3 is an assembly diagram showing major parts that constitute a fuel cell stack 111. Separators 181 and 191 are structured by electroconductive substrates which are formed from dense carbon plates. Whereas anode channels (fuel conduits) 1111 are formed by a plurality of grooves in the anode-side separator 181, cathode channels (air conduits) 1121 are formed by a plurality of grooves in the cathode-side separator 191.

And gaskets 1131 and 1141 as sealing material are placed between the periphery of the above-described electrolyte membrane 171 and the periphery of the above-mentioned separators 181 and 191, and then the above-mentioned cell 151 is held between the separators 181 and 191 to constitute a cell unit 161. Further, a plurality of cell units 161 are stacked one on another and the stack of the plurality of cell units 161 is held at the both ends thereof by end plates (not shown in FIG. 3) and fastened with a predetermined pressure to form a fuel cell stack 111.

Provided in the corners of the separators 181 and 191 are through-holes 1161, 1171, 1181, and 1191, which constitute manifolds for supplying or discharging methanol (fuel) or air (oxidant). The through-holes 1171 and 1191 thereamong are communicated with the anode channel 1111 of the separator 181, whereas the through-holes 1161 and 1181 are communicated with the cathode channel 1121 of the separator 191.

In the fuel cell stack 111, methanol is supplied to a liquid fuel supply manifold of the cell unit 161, and air is supplied to an oxidant supply manifold. Then the methanol supplied to the liquid fuel supply manifold is distributed to each of anode channels 1111 and thus supplied to the anode 121. On the other hand, the air supplied to the oxidant supply manifold is supplied through each of cathode channels 1121 to the cathode 131. And a resulting superfluous gas is discharged from the oxidant gas discharge manifold.

The methanol supplied to the anode 121 is first diffused almost uniformly in the gas diffusion layer 122 and then permeates the anode catalyst layer 123. Here, an anodic reaction (chemical formula 1) takes place in which methanol is oxidized by the catalyst in the anode catalyst layer 123. Then part of methanol that has permeated the anode catalyst layer 123 but has not contributed to the anodic reaction, namely, the methanol that has not become protons, permeates the fuel complexation layer 124 and forms a complex with cyclic hemiketal, which is a fuel complexation material 125 contained in the fuel complexation layer 124. Thereby, the methanol is held within the fuel complexation layer 124.

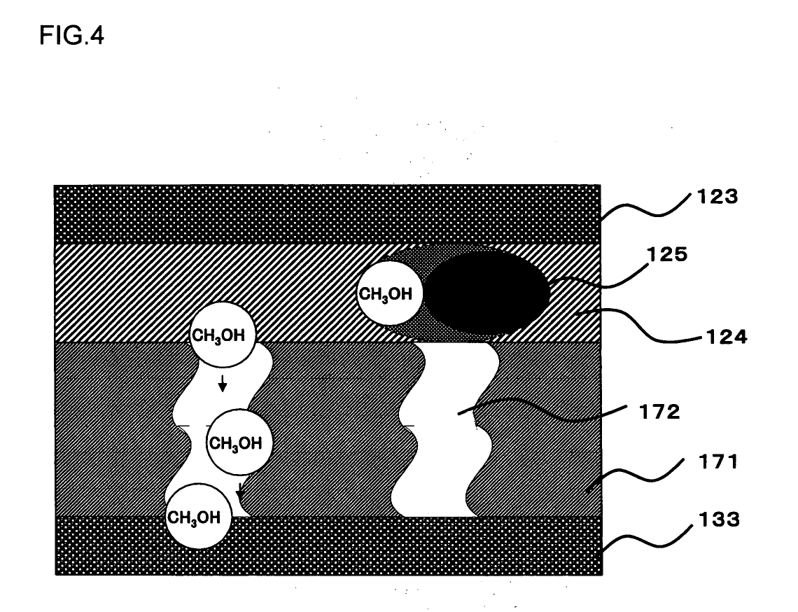

As shown in FIG. 4, a methanol complex molecule having a structure of a fuel complexation material 125 coordinated with a methanol molecule is larger than a methanol molecule, so that it cannot migrate easily through a pore 172 in the electrolyte membrane 171. This can suppress methanol from being permeated to the cathode side.

By employing the above-described structure, according to the first embodiment a fuel complexation layer 124 is formed on the surface of the anode catalyst layer 123. As a result, the methanol that has not contributed to the anodic reaction can be held within the fuel complexation layer 124, the crossover of methanol from the anode 121 side to the cathode 131 side through the electrolyte membrane 171 can be suppressed, and thus a drop in cell voltage can be prevented.

According to the first embodiment, the carbon paper as a porous support is one impregnated with a water-repellent material. And it is to be noted that the amount of the water-repellent material to be added should be 5 wt % to 80 wt % of the weight of the carbon paper after the impregnation. This arrangement ensures the conductivity of the carbon paper as the porous support, the prevention of clogging of holes within the structure, and the improved discharging of carbon dioxide generated in the oxidization.

In the first embodiment, polytetrafluoroethylene is used as the water-repellent material. In addition to this, a fluororesin such as a tetrafluoroethylene-perfluoroalkylvinylether copolymer, a tetrafluoroethylene-hexafluoropropylene copolymer, a polyvinylidene fluoride, polyvinyl fluoride fluorovinyl, perfluoroalkoxy, tetrafluoroethylene-ethylene copolymer, polychlorotrifluoroethylene, or polyethersulfone may be used.

In the first embodiment, carbon paper is used as the conductive porous support. In addition to this, a nonwoven-fabric type carbon fiber, a woven-fabric type carbon cloth, or a metal mesh such as a platinum mesh or a copper mesh coated with gold may be used.

### Second Embodiment

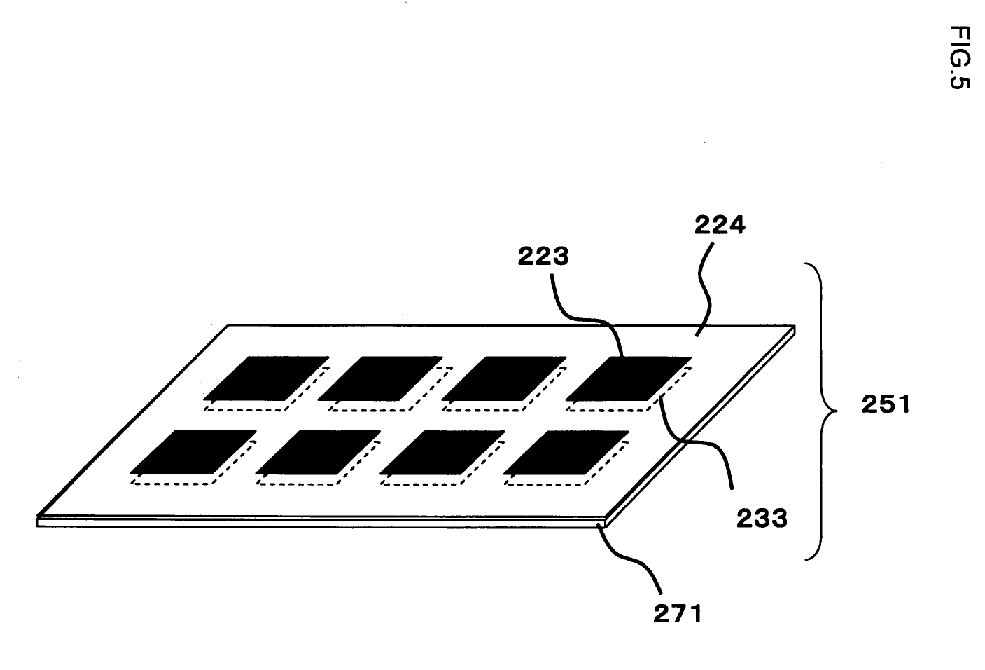

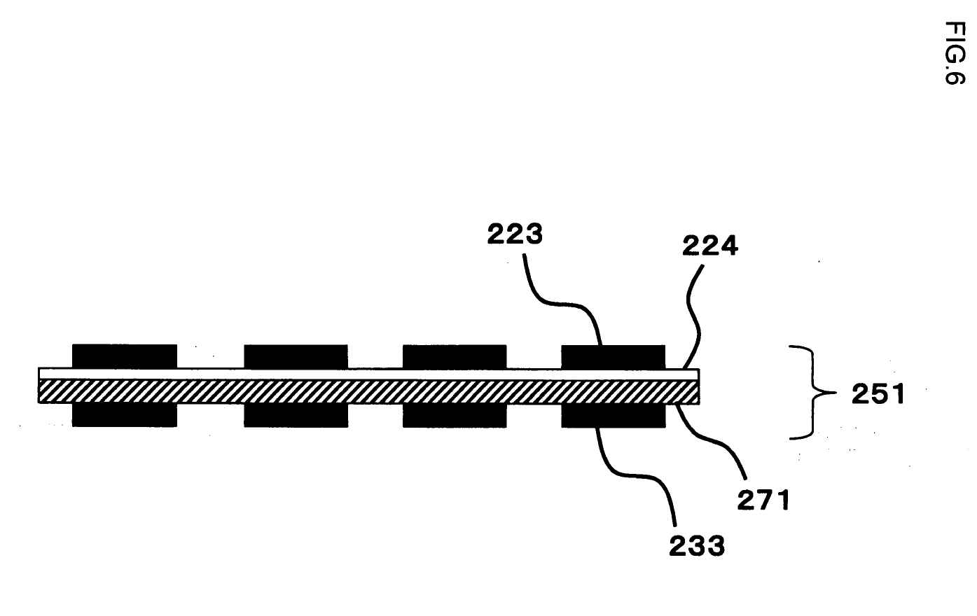

Next, as a second embodiment, a description will be given of a cell 251 with reference to FIG. 5 and FIG. 6. FIG. 5 is a perspective view of a cell 251 according to the second embodiment. FIG. 6 is a cross sectional view of the cell 251 according to the second embodiment.

According to the second embodiment, the whole surface of one side of an electrolyte membrane 271 is sprayed with a solution dissolving a cyclic hemiketal to form a fuel complexation layer 224. Then a masking in a form with a plurality of independent holes is applied to the surface where the fuel complexation layer 224 is formed on the electrolyte membrane 271. Then a catalyst layer ink, which has been prepared by mixing platinum-ruthenium black (catalyst particles) with a 5 wt % solution of DuPont's Nafion as a cation exchanger, is applied by spraying through the mask to the surface where the fuel complexation layer 224 has been formed on the electrolyte membrane 271. As a result, anode catalyst layers 223 are formed in areas that have not been masked, with the result that a plurality of independent anode catalyst layers 223 are disposed on the same plane on one side of the electrolyte membrane 271. In this case, the catalyst layer ink is prepared such that a weight ratio of the catalyst powder to the Nafion as the cation exchanger is 9 to 1.

Now, on the other side of the electrolyte membrane 271, cathode catalyst layers 233 are formed by spraying and applying a catalyst layer ink in positions counter to anode catalyst layers 223 across the electrolyte membrane 271. Note that a masking in a form with holes in positions counter to anodes across the electrolyte membrane is applied in the forming of the cathode catalyst layers 233. Thus a cell 251 is formed. The catalyst layer ink to be used here is prepared by mixing platinum black as catalyst powder with a 5 wt % solution of DuPont's Nafion as a cation exchanger. In this case, too, the catalyst layer ink is prepared such that a weight ratio of the catalyst powder to the Nafion as the cation exchanger is 9 to 1.

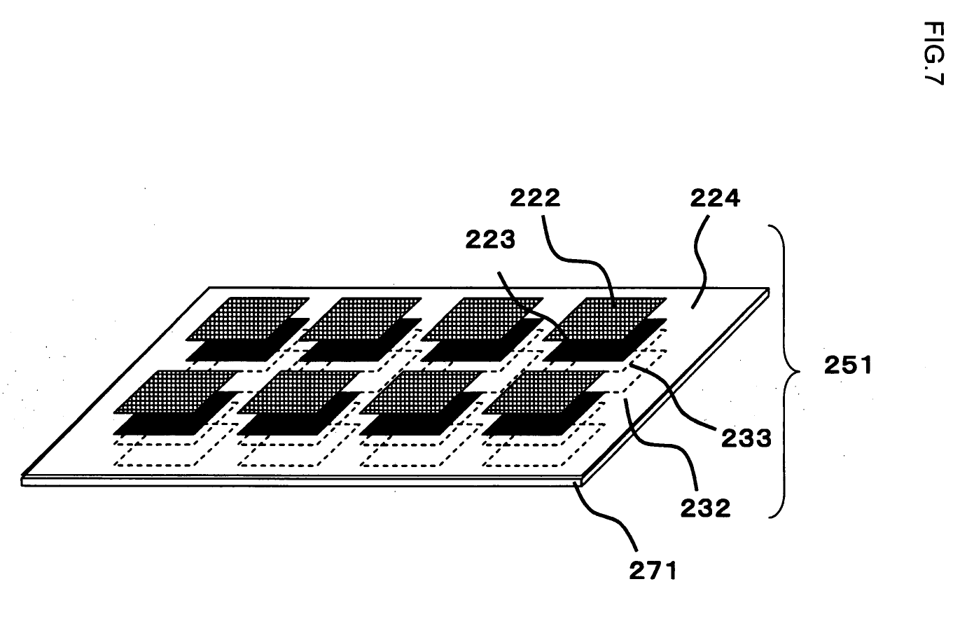

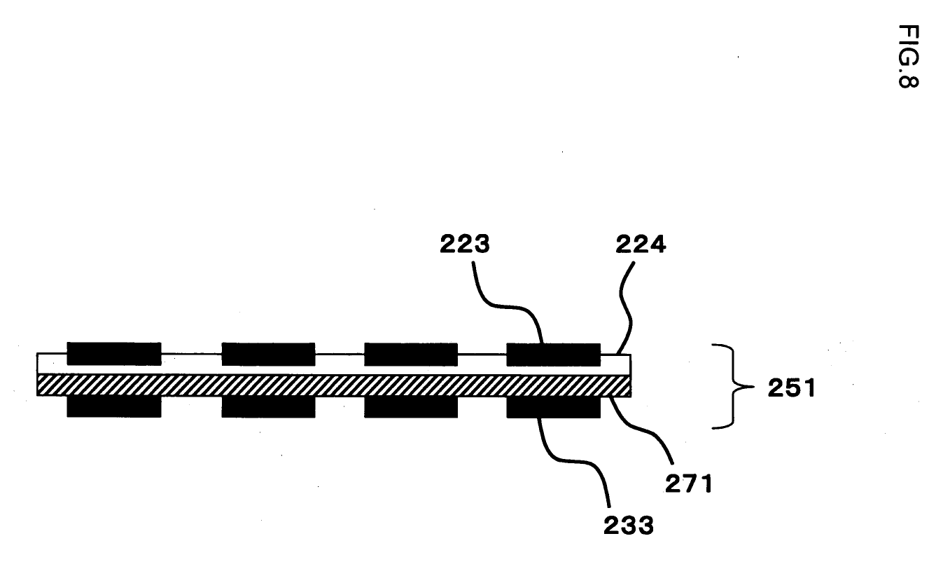

A cell 251, as shown in FIG. 7, may be so constituted that anode-side gas diffusion layers 222 are disposed on the upper faces of the respective anode catalyst layers 223 and cathode-side gas diffusion layers 232 are disposed on the lower faces of the respective cathode catalyst layers 233. In this second embodiment, a description has been given of a structure in which, as shown in FIG. 6, a fuel complexation layer 224 is formed in a uniform thickness all over the electrolyte membrane 271, but, as illustrated in FIG. 8, a fuel complexation layer 224 may be formed thicker than other portions in the regions where the electrolyte membrane 271 is not joined with anode catalyst layers 223 and is at the same time in contact with methanol.

### Third Embodiment

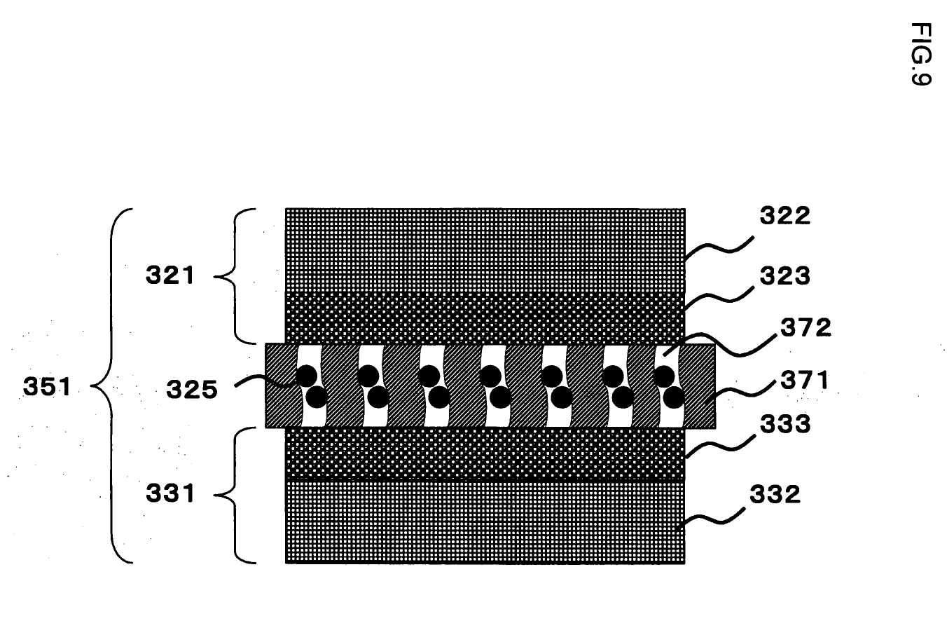

Next, as a third embodiment, a description will be given of a cell 351 with reference to FIG. 9. FIG. 9 is a cross sectional view of the cell 351 according to the third embodiment.

As shown in FIG. 9, in the third embodiment, pores 372 in an electrolyte membrane 371 are impregnated with cyclic hemiketal by immersing the electrolyte membrane 371 in a solution of cyclic hemiketal, which is a fuel complexation material 325.

An anode 321, as shown in FIG. 9, is of a laminated structure of a gas diffusion layer 322 and a cathode catalyst layer 323. The gas diffusion layer 322 of the anode 321 is produced by first preparing a slurry by mixing a polytetrafluoroethylene dispersion liquid as a water-repellent material with Cabot-made Vulcan XC-72 as a conductive material. A carbon paper (200 μm thick, for instance) as a conductive porous support is impregnated with FEP (a copolymer of ethylene tetrafluoride and propylene hexafluoride) to improve water repellence and strength. The above-described slurry is applied and filled, by a blade knife, within the carbon paper impregnated with FEP and is finally burnt by heating it at 380° C. Thereby, the gas diffusion layer 322 of the anode 321 is produced. Then a catalyst layer ink is prepared by mixing platinum-ruthenium black (catalyst particles) with a 5 wt % solution of DuPont's Nafion as a cation exchanger. Now the anode catalyst layer 323 is formed by applying the above-mentioned catalyst layer ink to the gas diffusion layer 322 by a screen printing method. Thereby, the anode 321 is formed. In this case, the catalyst layer ink is prepared such that a weight ratio of the catalyst powder to the Nafion as the cation exchanger is 9 to 1.

A cathode 331, as shown in FIG. 9, is of a laminated structure of a gas diffusion layer 332 and a cathode catalyst layer 333. The gas diffusion layer 332 of the cathode 331, in the same way as the above-mentioned gas diffusion layer 322 of the anode, is produced by first preparing a slurry by mixing a polytetrafluoroethylene dispersion liquid as a water-repellent material with Cabot-made Vulcan XC-72 as a conductive material. A carbon paper as a conductive porous support is impregnated with FEP, similarly to the gas diffusion layer 322 of the anode. The above-described slurry is applied and filled, by a blade knife, within the carbon paper impregnated with FEP and is finally burnt by heating it at 380° C. Then a catalyst layer ink is prepared by mixing platinum black as catalyst powder with a 5 wt % solution of DuPont's Nafion as a cation exchanger. Now the cathode catalyst layer 333 is formed by applying the above-mentioned catalyst layer ink to the gas diffusion layer 332 by a screen printing method. Thereby, the cathode 331 is formed. In this case, too, the catalyst layer ink is prepared such that a weight ratio of the catalyst powder to the Nafion as the cation exchanger is 9 to 1.

And the cell 351, having the electrolyte membrane 371 containing the fuel complexation material 325, which is held between the anode 321 and the cathode 331, is produced after being tight-molded by hot pressing at about 150° C., so that the anode 321, the electrolyte membrane 371 and the cathode 331 are joined in contact with one another.

### Fourth Embodiment

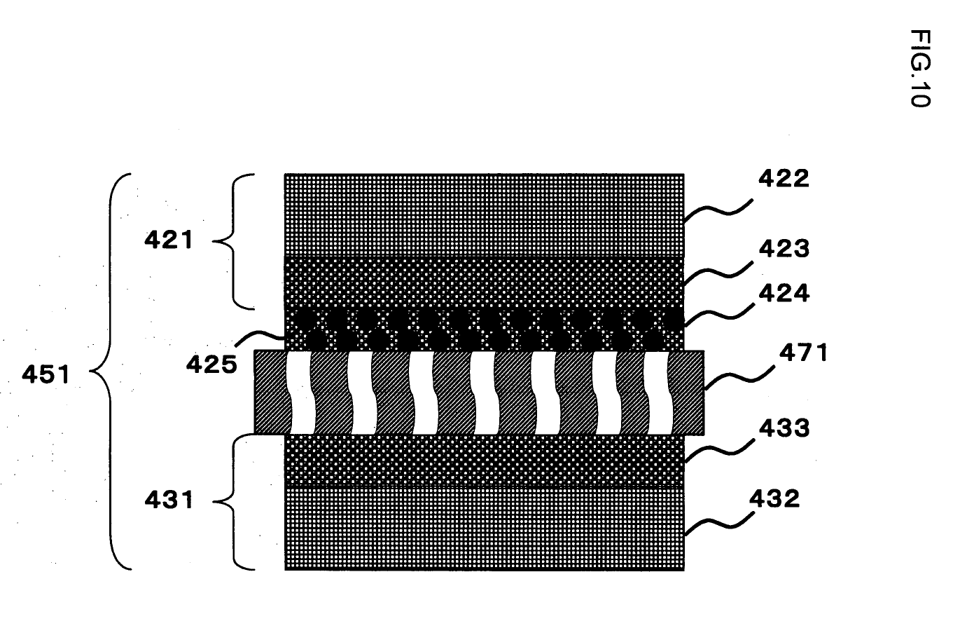

Next, as a fourth embodiment, a description will be given of a cell 451 with reference to FIG. 10. FIG. 10 is a cross sectional view of the cell 451 according to the fourth embodiment.

An anode 421, as shown in FIG. 10, is of a laminated structure of a gas diffusion layer 422, an anode first catalyst layer 423, and an anode second catalyst layer 424. First, a slurry is prepared by mixing a polytetrafluoroethylene dispersion liquid as a water-repellent material with Cabot-made Vulcan XC-72 as a conductive material. A carbon paper (200 μm thick, for instance) is impregnated with FEP (a copolymer of ethylene tetrafluoride and propylene hexafluoride) to improve water repellence and strength as a conductive porous support. Then the above-described slurry is applied and filled, by a blade knife, within a carbon paper impregnated with FEP and is finally burnt by heating it at 380° C. Thereby, the gas diffusion layer 422 of the anode 421 is produced. Then a catalyst layer ink A is prepared by mixing platinum-ruthenium black as catalyst powder with a 5 wt % solution of DuPont's Nafion as a cation exchanger. Also, a catalyst layer ink B is prepared by mixing the catalyst layer ink A with cyclic hemiketal as a fuel complexation material 425. Now the anode first catalyst layer 423 of the anode 421 is formed by applying the catalyst layer ink A to the gas diffusion layer 422 by a screen printing method, and further the anode second catalyst layer 424 thereof is formed by applying the catalyst layer ink B to the anode first catalyst layer 423 by the screen printing method. In this case, the catalyst layer ink is prepared such that a weight ratio of the catalyst powder to the Nafion as the cation exchanger is 9 to 1.

The arrangement may also be such that the anode 421 is not of a two-layer structure of anode catalyst layers 423 and 424 as described above, that the anode catalyst layer is composed of platinum black powder, cation exchanger and fuel complexation material 425, and that the fuel complexation material 425 increases in content in the anode thickness direction toward the electrolyte membrane 471 and is in contact with the electrolyte membrane 471.

A cathode 431, as shown in FIG. 10, is of a laminated structure of a gas diffusion layer 432 and a cathode catalyst layer 433. The gas diffusion layer 432 of the cathode 431, in the same way as the above-described gas diffusion layer 422 of the anode, is produced by first preparing a slurry by mixing a polytetrafluoroethylene dispersion liquid as a water-repellent material with Cabot-made Vulcan XC-72 as a conductive material, then applying and filling with a blade knife the above-described slurry on a carbon paper impregnated with FEP as a conductive porous support, similarly to the gas diffusion layer 422 of the anode, and finally burning the layer by heating it at 380° C. Then a catalyst layer ink is prepared by mixing platinum black as catalyst powder with a 5 wt % solution of DuPont's Nafion as a cation exchanger. Now the cathode catalyst layer 433 is formed by applying the above-described catalyst layer ink to the gas diffusion layer 432 by the screen printing method. Thereby, the cathode 431 is formed. In this case, too, the catalyst layer ink is prepared such that a weight ratio of the catalyst powder to the Nafion as the cation exchanger is 9 to 1.

And the cell 451, with the electrolyte membrane 471 held between the anode 421 and the cathode 431, is produced after being tight-molded by hot pressing at about 150° C., so that the anode 421, the electrolyte membrane 471 and the cathode 431 are joined in contact with one another.

### Fifth Embodiment

N,N,N′,N′-tetracyclohexylfumaramide is used as fuel complexation material, and the methanol permeation volume of an electrolyte membrane containing the fuel complexation material was measured. Sample 1 is produced such that the fuel complexation material solution, in which 0.05 grams of N,N,N′,N′-tetracyclohexylfumaramide is dissolved with 10 mL of diethyl ether, is mixed with a 5 wt % solution of Nafion so that a weight ratio of the fuel complexation material solution to Nafion is 1 to 1, and the mixture is applied to the surface of one side of an electrolyte membrane so as to be dried at room temperature, and thereafter it is subjected to a hot pressing at 130° C. and 5 MPa. Sample 2 is produced by applying the fuel complexation material solution, in which 0.05 grams of N,N,N′,N′-tetracyclohexylfumaramide is dissolved with 10 mL of diethyl ether, to the surface of one side of an electrolyte membrane and then drying it at room temperature. As a comparative example, an electrolyte membrane without the fuel complexation material is used.

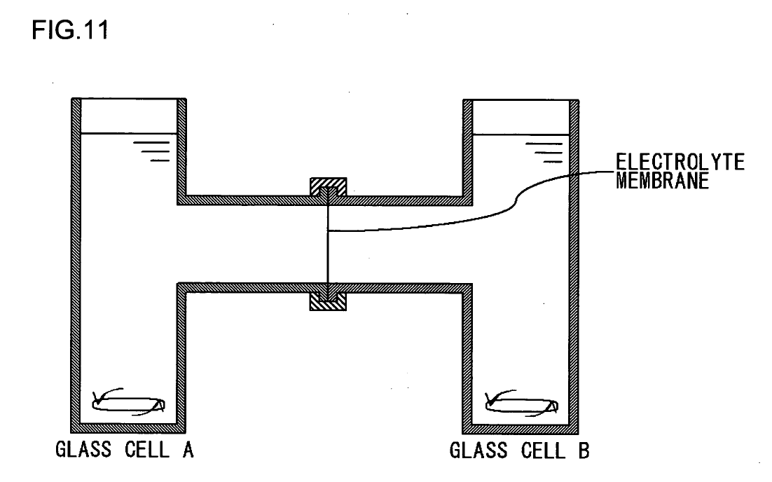

Sample 1 and sample 2 weigh 18 mg and 17 mg, respectively, and the electrolyte membrane used as the comparative example weighs 12 mg. For sample 1, sample 2 and the comparative example, the methanol permeation volume thereof was measured using a two-chamber method as shown in FIG. 11. The mixed solution of 2 mol methanol and 0.1 mol ethanol is put in glass cell A. The ethanol solution of 0.1 mol is put in glass cell B. Sample 1 and sample 2 are so placed that the surface of one side of the electrolyte membrane containing the fuel complexation material is at the side of glass cell A. And the electrolyte membrane is held by a glass cell. The volume of methanol permeation from glass cell A to glass cell B, namely, the methanol concentration of glass cell B is measured by a gas chromatography.

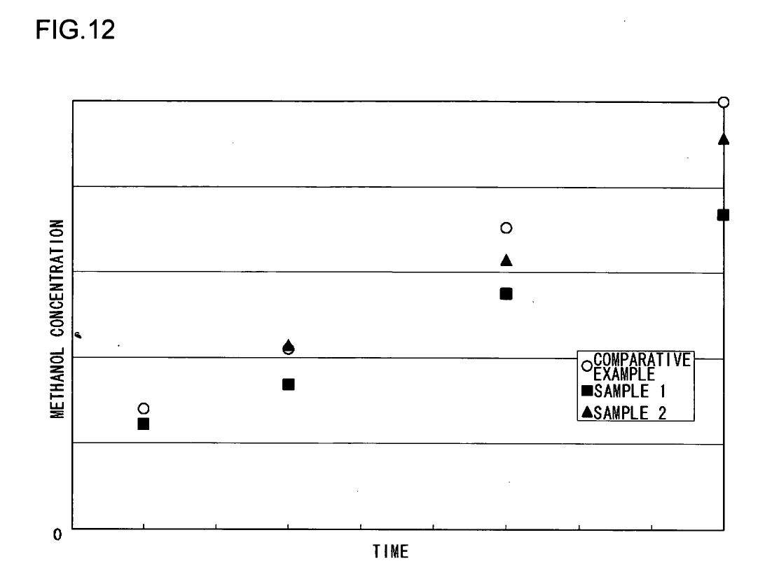

As evident from FIG. 12, the effect of inhibiting the methanol excels in the samples that contain the fuel complex material in comparison with the comparative example having the electrolyte membrane alone. In particular, since the fuel complexation material is fixed to the electrolyte membrane in sample 1 where the fuel complexation solution and the Nafion solution are mixed and the mixture is hot-pressed, the sample 1 achieves the effect of inhibiting the permeation of methanol to the full extent.

Additional Matters and Modifications

In the first to the fourth embodiment, DuPont's Nafion membrane is used as the electrolyte membrane. In addition to this, fluorine-containing polymers or hydrocarbon polymers containing sulfonic acid groups, hydroxyl groups or the like, polymers containing basic functional groups, such as polybenzimidazole, and their composite materials may be used. In the above embodiments, the weight ratio of DuPont's Nafion as the cation exchanger contained in the anode catalyst layer is 10 wt % of the catalyst constituting the anode catalyst layer. In addition to this, 1 wt % to 70 wt %, preferably, 5 wt % to 50 wt %, of the weight of the catalyst constituting the anode catalyst layer may be used. Such weight ratios also assure output improvement of the fuel cell.

In addition, according to the embodiments described above, a binary alloy of platinum-ruthenium black as catalyst particles constituting the anode catalyst layer is used. In addition to this, binary alloys, such as platinum-molybdenum, platinum-iridium, platinum-tin, platinum-tungsten, platinum-titanium and platinum-rhodium, and ternary or more-component (multicomponent) alloys combining such elements may be used. Catalyst metals supporting carbon black may also be used. According to the embodiments described above, the catalyst constituting the cathode catalyst layer is made of platinum only, but, in addition to that, a mixture of platinum and ruthenium may be used. In this case, however, the content of platinum needs to be 40% or more. Moreover, platinum black is used as catalyst particles constituting the cathode catalyst layer, but, in addition to that, a combination of alloys constituting the catalyst particles constituting the anode catalyst layer, or the catalyst metals supporting the carbon black may be used.

Furthermore, according to the embodiments described above, cyclic hemiketal is used as the fuel complexation material when methanol is used as the liquid fuel. In addition to this, boron trifluoride or N,N,N′,N′-tetracyclohexylfumaramide may be used as a suitable fuel complexation material. However, use of cyclic hemiketal or N,N,N′,N′-tetracyclohexylfumaramide is preferred because boron trifluoride, which is gaseous at normal temperature, is harder to handle than cyclic hemiketal or N,N,N′,N′-tetracyclohexylfumaramide. Also, spraying is used as the method for forming the fuel complexation layer, but, in addition to that, such methods as screen printing, doctor blade and die coating may be used. It is to be noted, however, that the spray method makes it possible to easily form a thin fuel complexation layer. According to the embodiments described above, the fuel complexation layer is formed by applying a solution dissolving a fuel complexation material by a spraying method; however, it may be a mixed layer of a fuel complexation material and a cation exchanger, which is formed by spraying the above-described solution mixed with DuPont's Nafion as the cation exchanger. This arrangement can produce such advantageous effects as a better adhesion of an anode catalyst layer and an electrolyte membrane via a fuel complexation layer and an improved proton conductivity. According to the embodiments described above, the fuel complexation layer is disposed at the interface between the anode catalyst layer and the electrolyte membrane. However, the fuel complexation layer may be disposed at the interface between the electrolyte membrane and the cathode if it is to prevent the voltage drop due to the oxidization at the cathode of methanol having crossed over from the anode side or to prevent the combustion reaction at the cathode of methanol having crossed over. This arrangement can also prevent the methanol having crossed over from migrating to the cathode.

Finally, according to the above embodiments, methanol is used as the liquid fuel. However, other liquid fuels such as ethanol, propanol, butanol, trimethoxymethane, ethylene glycol and formic acid may be coordinated to form a complex that can achieve similar advantageous effects. According to the above embodiments, air is cited as the oxidant gas, but oxygen or hydrogen peroxide solution can achieve similar advantageous effects, too.

### INDUSTRIAL APPLICABILITY

The present invention is applicable not only to fuel cells, such as DMFC, which are supplied with liquid fuel, but also to fuel cells, in which fuel gas or oxidant gas crosses over the electrolyte layer provided that a material forming a complex is used by coordinating the fuel gas or oxidant gas.

While the preferred embodiments of the present invention have been described using specific terms, such description is for illustrative purposes only, and it is to be understood that changes and variations may be made without departing from the spirit or scope of the appended claims.

What is claimed is:

1. A cell in which an anode and a cathode is provided at both sides of an electrolyte layer, liquid fuel is supplied to the anode and oxidant is supplied to the cathode, the cell including:
a fuel complexation material which forms a complex by coordinating the liquid fuel.

2. A cell according to claim 1, further including a fuel complexation layer, provided at an anode side of the electrolyte layer, which contains the fuel complexation material.

3. A cell according to claim 2, wherein said fuel complexation layer is provided at least at the anode side of the electrolyte layer and on a surface on which the anode is not placed.

4. A cell according to claim 2, wherein said fuel complexation layer contains cation exchanger.

5. A cell according to claim 3, wherein said fuel complexation layer contains cation exchanger.

6. A cell according to claim 1, wherein said fuel complexation material is cyclic hemiketal or boron trifluoride.

7. A cell according to claim 2, wherein said fuel complexation material is cyclic hemiketal or boron trifluoride.

8. A cell according to claim 3, wherein said fuel complexation material is cyclic hemiketal or boron trifluoride.

9. A cell according to claim 1, wherein the liquid fuel contains methanol.

10. A cell according to claim 2, wherein the liquid fuel contains methanol.

11. A cell according to claim 3, wherein the liquid fuel contains methanol.

12. A fuel cell using a cell according to claim 1.

13. A fuel cell using a cell according to claim 2.

14. A fuel cell using a cell according to claim 3.
